(19) United States
(12) Patent Application Publication
(10) Pub. No.: US 2026/0028501 A1
(43) Pub. Date: Jan. 29, 2026

(54) THERMAL INSULATION COATING COMPOSITION AND THERMAL INSULATION COATING FORMED THEREFROM

(71) Applicant: Industrial Technology Research Institute, Hsinchu (TW)

(72) Inventors: Yeu-Kuen Wei, Hsinchu City (TW); Yi-Che Su, Hsinchu County (TW); Yuan-Chang Huang, Hsinchu City (TW); Ying-Chen Liao, Hsinchu County (TW); Ya-I Hsu, Hsinchu City (TW); Chih-Chien Chen, Hsinchu City (TW)

(73) Assignee: Industrial Technology Research Institute, Hsinchu (TW)

(21) Appl. No.: 19/002,633

(22) Filed: Dec. 26, 2024

(30) Foreign Application Priority Data
Jul. 26, 2024 (TW) 113127856

(51) Int. Cl. C09D 133/08; B05D 1/02; B05D 7/00; C09D 7/40; C09D 7/61; C09D 175/04

(52) U.S. Cl. CPC C09D 133/08; B05D 1/02; B05D 7/50; C09D 7/61; C09D 7/70; C09D 175/04; B05D 2502/00; B05D 2503/00; B05D 2601/22

(57) ABSTRACT

A thermal insulation coating composition and a thermal insulation coating formed therefrom are provided. The thermal insulation coating composition includes an aqueous resin, a hydrophobic aerogel powder, a hollow powder, and an associative resin thickener. Based on 100 parts by weight of a total amount of the thermal insulation coating composition, a content of the aqueous resin is 70 parts by weight to 85 parts by weight, a content of the hydrophobic aerogel powder is 2 parts by weight to 15 parts by weight, and a content of the hollow powder is 10 parts by weight to 25 parts by weight. Based on 100 parts by weight of an amount of the aqueous resin, a content of the associative resin thickener is 0.1 part by weight to 1 part by weight.

### CROSS-REFERENCE TO RELATED APPLICATION

This application claims the priority benefit of Taiwan application serial no. 113127856, filed on Jul. 26, 2024. The entirety of the above-mentioned patent application is hereby incorporated by reference herein and made a part of this specification.

### TECHNICAL FIELD

The disclosure relates to a thermal insulation coating composition having high ductility and low heat transfer and a thermal insulation coating formed therefrom.

### BACKGROUND

Energy is essential for most activities of modern society. In order to achieve high energy saving and carbon reduction, surfaces of metal structure such as industrial conveying pipelines or barrels must be effectively insulated. Conventional thermal insulation materials include rock wool, aerogel blankets, foamed polyurethane, etc. However, these materials have poor durability, inconvenient constructability and need a certain thickness to achieve better thermal insulation performance. Moreover, frequent replacement of the thermal insulation materials cause environmental pollution problems.

In addition, since the aforementioned thermal insulation materials are mostly wrapped to metal surfaces, the construction process becomes complicated under complex facility structure, and the wrapped materials may not closely adhere to the metal surfaces. After a long period usage, condensed water may intrude into the gaps therebetween, which accelerates the corrosion of the pipelines or barrels, and increases safety concern. Accordingly, more man-power, time, and resources are needed to resolve with the issue.

Common spray-type thermal insulation coatings, such as inorganic thermal insulation mortar coatings and hollow ceramic can form a protection layer in surface insulation application to protect personnel from burn hazard. However, since the coatings are hard, and are often difficult to handle during subsequent material maintenance and replacement. Therefore, there is an urgent need to develop a thermal insulation material that may solve the above problems.

### SUMMARY

The disclosure provides a thermal insulation coating composition having the properties of fewer coating steps and forming a thick wet film without sagging phenomenon.

The disclosure also provides a thermal insulation coating having high thermal resistance, low heat transfer, and high ductility, and is easy to remove.

A thermal insulation coating composition of the disclosure includes an aqueous resin, hydrophobic aerogel powders, hollow powders, and an associative resin thickener. Based on 100 parts by weight of a total amount of the thermal insulation coating composition, a content of the aqueous resin is 70 parts by weight to 85 parts by weight, a content of the hydrophobic aerogel powders is 2 parts by weight to 15 parts by weight, and a content of the hollow powders is 10 parts by weight to 25 parts by weight. Based on 100 parts by weight of the amount of the aqueous resin, a content of the associative resin thickener is 0.1 part by weight to 1 part by weight.

A thermal insulation coating of the disclosure is a film formed by spraying the above thermal insulation coating composition.

Based on the above, the composition of the disclosure contains a high proportion of an organic material in combination with a porous inorganic material and a specific thickener, in which the hydrophobic aerogel powders and the aqueous resin are used as main components. By utilizing the hollow powders, the water-based resin infiltration into the micropores of the hydrophobic aerogel powder is reduced, and the hydrophilic associative resin thickener is introduced. Accordingly, the composition can produce a high-porosity thermal insulating that is easy to apply and can be continuously coated. The coating layers obtained from the composition possess both high ductility and crack-resistant properties, as well as low thermal conductivity and insulation performance. Furthermore, the high ductility coatings are easy to remove and may reduce the amount of residue left on the substrate after peeling.

Several exemplary embodiments are described in detail below to further describe the disclosure in details.

### DETAILED DESCRIPTION OF DISCLOSED EMBODIMENTS

The following disclosure provides many different embodiments, or examples, for implementing different features of the provided subject matter. These are, of course, merely examples and are not intended to be limiting. In addition, the terms “comprise”, “include”, “have” and the like, may be used herein for meaning “containing but not limited to”.

Herein, a range indicated by “one value to another value” is a general representation to avoid enumerating all values in the range in the specification. Therefore, the recitation of a specific numerical range covers any number within this numerical range and any smaller numerical range bounded by any number within that numerical range as described in the specification.

In some embodiments of the disclosure, a thermal insulation coating composition includes an aqueous resin, hydrophobic aerogel powders, hollow powders, and an associative resin thickener. Hereinafter, the foregoing components are described in detail.

### <Aqueous Resin>

The aqueous resin includes an acrylic resin, a polyurethane resin, or a combination of the acrylic resin and the polyurethane resin.

Based on 100 parts by weight of the total amount of the thermal insulation coating composition, the content of the aqueous resin is 70 parts by weight to 85 parts by weight. If the content of the aqueous resin is less than 70 parts by weight, the thermal insulation coating composition has poor ductility; if the content of the aqueous resin is greater than 85 parts by weight, it will result in poor thermal insulation performance.

### <Hydrophobic Aerogel Powder>

The hydrophobic aerogel powders include a silica aerogel or other suitable aerogel powders. Commercially available silica aerogels include, but are not limited to, P0-0500 and P1-0500 purchased from ABIS, or AeroVa® purchased from JIOS Aerogel.

Based on 100 parts by weight of the total amount of the thermal insulation coating composition, the content of the hydrophobic aerogel powders is 2 parts by weight to 15 parts by weight. If the content of the hydrophobic aerogel powders is less than 2 parts by weight, the thermal insulation effect is poor; if the content of the hydrophobic aerogel powders is greater than 15 parts by weight, the aerogel may be unevenly dispersed, which causes delamination to occur.

### <Hollow Powder>

The hollow powders include a hollow glass sphere, a hollow plastic microsphere, or a combination of the above. Commercially available hollow powders include, but are not limited to, SG(500) E-RN purchased from Fillite, K series, S series, iM series, XLD series purchased from 3M™ Glass Bubbles, etc.; or the DE series of Expancel® Microspheres purchased from Boud Minerals. The particle size (volume: 50%) and the density of the M hollow glass sphere series are about 20 μm to 65 μm, and 0.1 g/cm³ to 0.6 g/cm³, respectively. The particle size (volume: 50%) and the density of the DE series hollow plastic microsphere are approximately 15 μm to 55 μm, and 0.02 g/cm³ to 0.08 g/cm³, respectively.

Based on 100 parts by weight of the total amount of the thermal insulation coating composition, the content of the hollow powders is 10 parts by weight to 25 parts by weight. If the content of the hollow powders is less than 10 parts by weight, the thermal insulation effect is poor; if the content of the hollow powders is greater than 25 parts by weight, there is an issue of poor ductility.

In an embodiment, the weight ratio of the hydrophobic aerogel powders to the hollow powders is between 1:1 and 1:6. If the weight ratio of the hydrophobic aerogel powders to the hollow powders is greater than 1, the surface of the thermal insulation coating composition is slightly sticky and has poor compressive resistance. If the weight ratio is between 1 and 0.16, the surface is dry and has good thermal insulation, ductility, and compressive resistance. If the weight ratio is less than 0.16, the thermal insulation effect and the ductility are both poor.

### <Associative Resin Thickener>

The associative resin thickener may be a thickener containing a polyurethane resin or a modified polyurethane resin. For example, the associative resin thickener may be an associative resin for which the main chain contains hydrophilic polyurethane and the side chain contains hydrophobic polyethylene, but is not limited thereto.

In an embodiment, the associative resin thickener contains a polyether polyurea polyurethane resin (also known as polyether poly(urethane-urea) polymer) or other suitable associative resin thickeners.

Commercially available associative resin thickeners include, but are not limited to, RHEOBYK-H7625VF, RHEOBYK-420, or RHEOBYK-425 of BYK; RHEOLATE® 278, RHEOLATE® 255, RHEOLATE® 288, or RHEOLATE® FX1010 of ELEMENTIS.

Based on 100 parts by weight of the amount of the aqueous resin, the content of the associative resin thickener is 0.1 part by weight to 1 part by weight. If the content of the associative resin thickener is less than 0.1 part by weight, the coating easily sags and can not achieve a single coating with a thickness of 1 mm to 2 mm; if the content of the associative resin thickener is greater than 1 part by weight, the fluidity of the coating composition deteriorate and make it difficult to be applied by spraying.

### <Additive>

The additive includes a dispersant, a defoaming agent, a leveling agent, or a combination of the above. Based on 100 parts by weight of the amount of the aqueous resin, the contents of the additives above are 0.1 part by weight to 1 part by weight respectively.

Some embodiments of the disclosure also provide a thermal insulation coating, which is a film formed by spraying the thermal insulation coating composition. The equipment used for the above spraying may include, but is not limited to, an air spray gun, an airless sprayer, a screw sprayer, etc. More specifically, the thermal insulation coating is a coating obtained by spraying multiple times. In the present embodiment, there is no limitation on the range of the total number of layers of the coating and the overall thickness of the thermal insulation coating, which are mainly determined based on the application thereof. For example, the total thickness of the thermal insulation coating may be between 1 mm and 10 mm, but is not limited thereto.

The thermal insulation coating has a single coating thickness of, for example, 1 mm to 2 mm, a thermal conductivity of 0.05 W/m·K to 0.07 W/m·K, a thixotropy of ≥10, and a percentage elongation of ≥150%. In an embodiment, the thermal resistance of a single-layer thermal insulation coating is ≥0.03 m²·K/W.

Since the thickness of the thermal insulation coating composition of the disclosure may reach 2 mm in a single spraying (without sagging), the thermal insulation coating may achieve a higher thermal resistance with a fewest number of spraying counts.

In the following, the thermal insulation coating composition provided by the disclosure and the thermal insulation coating obtained by spraying are described in detail through experiments. However, the following experiments are not intended to limit the disclosure.

### <Raw Material>

Aqueous acrylic resin: Eternal Materials ETERSOL 6512-1.
Aqueous polyurethane resin: Ultra-Chems T-23.
Silicone-modified aqueous acrylic resin: Grand-Tek Advance Material Science, GT-138.
Silicone resin: DOW DOWSIL™ 8005.
Dispersant: DOW TAMOL™ 731A.
Defoaming agent: DOW DOWSIL™ AF-8014.
Silica aerogel: JIOS Aero Va®.
Hollow powder: 3M™ Glass Bubbles K25, Expancel® DE40.
Associative resin thickener: ELEMENTIS RHEOLATE® R288.
Non-associative resin thickener: BYK RHEOBYK-420 (urea-modified solution).
Commercially available coating composition: Mascoat DTI.

### Example 1

90 g of an aqueous acrylic resin, 90 g of an aqueous polyurethane resin, 3.3 g of a dispersant, and 0.7 g of a defoaming agent were put into a mechanical stirring equipment and stirred to obtain a uniform mixture. Then, 5.7 g of a silica aerogel was slowly added into the mixture and dispersed at a stirring speed of 800 rpm. Lastly, 20.4 g of 3M™ Glass Bubbles K25 hollow powders and 0.7 g of an associative resin thickener were added to obtain a thermal insulation coating composition.

The thermal insulation coating composition was then subjected to the following measurements:

### 1. Organic Content and Inorganic Content

According to ASTM E1131 standard test method for compositional analysis thermogravimetric, measurement was performed using a thermogravimetric analyzer (TGA Q500, American Waters) to confirm the content of the organic material and the inorganic material.

### 2. Material Percentage Elongation

A specimen was prepared by drying a composition coating, and was cut to a dumbbell shape using a cutter. The percentage elongation of the specimen was measured according to ASTM D-412 C standard. The tensile speed of the chuck movement was set at a rate of 500 mm/min using a tensile machine (HT-2012AP, Hung Ta Instrument) to stretch the specimen to rupture. The percentage elongation of the specimen was obtained by measuring the length of the specimen at break to that of the original specimen.

### 3. Thermal Conductivity

The composition was dried and made into a bulk specimen. According to ISO 22007-2, testing was performed using a thermal conductivity meter (Hot Disk TPS2500S, TechMax Technical Group) to obtain the thermal conductivity.

4. Coating Thickness without Sagging

A coating composition was sprayed on a substrate by using a spraying equipment and erected vertically on the ground to visually determine whether there is sagging. Then, the thickness was measured using a wet film thickness meter (complying with ASTM D4414 standard, with a measuring range of 25 μm to 2000 μm, and 2 mm to 10 mm).

The resulting thermal insulation material was tested as above to obtain an organic content of 75%, an inorganic content of 25%, a material percentage elongation of 255%, a thermal conductivity of 0.05260 W/m·K, and a coating thickness of 2 mm without sagging.

### Example 2

180 g of an aqueous acrylic resin, 3.6 g of a dispersant, and 0.7 g of a defoaming agent were put into a mechanical stirring equipment and stirred to obtain a uniform mixture. Then, 3.5 g of a silica aerogel was slowly added into the mixture and dispersed at a stirring speed of 800 rpm. Lastly, 16.8 g of 3M™ Glass Bubbles K25 hollow powders and 0.7 g of an associative resin thickener were added to obtain a thermal insulation coating composition.

The resulting thermal insulation coating composition was tested as above to obtain an organic content of 74.4%, an inorganic content of 25.6%, a material percentage elongation of 210%, a thermal conductivity of 0.05848 W/m·K, and a coating thickness of 2 mm without sagging.

### Example 3

120 g of an aqueous acrylic resin, 30 g of a silicone-modified aqueous acrylic resin, 2.8 g of a dispersant, and 0.6 g of a defoaming agent were put into a mechanical stirring equipment and stirred to obtain a uniform mixture. Then, 3.0 g of a silica aerogel was slowly added into the mixture and dispersed at a stirring speed of 800 rpm. Lastly, 16.8 g of 3M™ Glass Bubbles K25 hollow powders and 0.3 g of an associative resin thickener were added to obtain a thermal insulation coating composition.

The resulting thermal insulation coating composition was tested as above to obtain an organic content of 78.4%, an inorganic content of 21.6%, a material percentage elongation of 335%, a thermal conductivity of 0.06434 W/m·K, and a coating thickness of 1.5 mm without sagging.

### Example 4

150 g of an aqueous acrylic resin, 2.6 g of a dispersant, and 0.5 g of a defoaming agent were put into a mechanical stirring equipment and stirred to obtain a uniform mixture. Then, 5.8 g of a silica aerogel was slowly added into the mixture and dispersed at a stirring speed of 800 rpm. Lastly, 8.5 g of 3M™ Glass Bubbles K25 hollow powders, 0.85 g of Expancel® DE40 hollow powders, and 0.6 g of an associative resin thickener were added to obtain a thermal insulation coating composition.

The resulting thermal insulation coating composition was tested as above to obtain an organic content of 84.5%, an inorganic content of 15.5%, a material elongation=254%, a thermal conductivity of 0.06748 W/m·K, and a coating thickness of 2 mm without sagging.

### Comparative Example 1

A Mascoat DTI commercial product was used as the thermal insulation coating composition. After testing, Mascoat DTI had an organic content of 51.5%, an inorganic content of 48.5%, a coating percentage elongation of 38%, a thermal conductivity of 0.067 W/m·K, and a coating thickness of 0.5 mm with the occurrence of sagging.

### Comparative Example 2

180 g of an aqueous acrylic resin, 3.5 g of a dispersant, and 0.7 g of a defoaming agent were put into a mechanical stirring equipment and stirred to obtain a uniform mixture. Then, 31.0 g of a hollow glass and 0.5 g of an associative resin thickener were added to obtain a thermal insulation coating composition.

The resulting thermal insulation coating composition was tested as above to obtain an organic content of 73.3%, an inorganic content of 26.7%, a material percentage elongation of 46%, a thermal conductivity of 0.06868 W/m·K, and a coating thickness of 1.2 mm without sagging.

### Comparative Example 3

150 g of an aqueous acrylic resin, 2.9 g of a dispersant, and 0.6 g of a defoaming agent were put into a mechanical stirring equipment and stirred to obtain a uniform mixture. Then, 3.25 g of a silica aerogel was slowly added into the mixture and dispersed at a stirring speed of 800 rpm. Lastly, 22.5 g of a hollow glass was added to obtain a thermal insulation coating composition.

The resulting thermal insulation coating composition was tested as above to obtain an organic content of 75.1%, an inorganic content of 24.9%, a material percentage elongation of 118%, a thermal conductivity of 0.06345 W/m·K, and a coating thickness of 0.2 mm with the occurrence of sagging.

### Comparative Example 4

90 g of an aqueous acrylic resin, 90 g of an aqueous polyurethane resin, 3.3 g of a dispersant, and 0.7 g of a defoaming agent were put into a mechanical stirring equipment and stirred to obtain a uniform mixture. Then, 5.7 g of a silica aerogel was slowly added into the mixture and dispersed at a stirring speed of 800 rpm. Lastly, 20.4 g of a hollow glass and 0.3 g of an associative resin thickener were added to obtain a thermal insulation coating composition.

The resulting thermal insulation coating composition was tested as above to obtain an organic content of 86.2%, an inorganic content of 13.8%, a material percentage elongation of 285%, a thermal conductivity of 0.07922 W/m·K, and a coating thickness of 0.5 mm with the occurrence of sagging.

### Comparative Example 5

120 g of an aqueous acrylic resin, 60 g of water, 2.3 g of a dispersant, and 0.5 g of a defoaming agent were put into a mechanical stirring equipment and stirred to obtain a uniform mixture. Then, 5.6 g of a silica aerogel was slowly added into the mixture and dispersed at a stirring speed of 800 rpm. Lastly, 24 g of a hollow glass was added to obtain a thermal insulation coating composition.

The resulting thermal insulation coating composition was tested as above to obtain an organic content of 60.8%, an inorganic content of 39.2%, a material percentage elongation of 87%, a thermal conductivity of 0.05676 W/m·K, and a coating thickness of 0.3 mm with the occurrence of sagging.

### Comparative Example 6

120 g of an aqueous acrylic resin, 60 g of an aqueous polyurethane resin, 3.4 g of a dispersant, and 0.8 g of a defoaming agent were put into a mechanical stirring equipment and stirred to obtain a uniform mixture. Then, 5.5 g of a silica aerogel was slowly added into the mixture and dispersed at a stirring speed of 800 rpm. Lastly, 24.5 g of a hollow glass and 0.72 g of a non-associative resin thickener were added to obtain a thermal insulation coating composition.

The resulting thermal insulation coating composition was tested as above to obtain an organic content of 74.5%, an inorganic content of 25.5%, a material percentage elongation of 255%, a thermal conductivity of 0.05260 W/m·K, and a coating thickness of 0.4 mm with the occurrence of sagging.

### Comparative Example 7

180 g of an aqueous acrylic resin, 3.4 g of a dispersant, and 0.8 g of a defoaming agent were put into a mechanical stirring equipment and stirred to obtain a uniform mixture. Then, 12 g of a silica aerogel was slowly added into the mixture and dispersed at a stirring speed of 800 rpm. Lastly, 0.9 g of a non-associative resin thickener was added to obtain a thermal insulation coating composition.

The resulting thermal insulation coating composition was tested as above to obtain an organic content of 87%, an inorganic content of 12%, a material percentage elongation of 30%, a thermal conductivity of 0.06908 W/m·K, and a coating thickness of 0.3 mm with the occurrence of sagging.

In addition, properties such as viscosity, viscosity recovery, and thixotropy of the thermal insulation coating compositions of Examples 1 to 4 and Comparative examples 1 to 7 were measured respectively, wherein the viscosity and the viscosity recovery were measured using a controlled shear/shear rate rheometer. The shear rate ramped up from 10 s⁻¹ to 1000 s⁻¹ and then ramped down to 10 s⁻¹ was set as one cycle, and the values changing with the shear rate were recorded. The viscosity recovery was divided by the viscosity to obtain the thixotropy. Then, the proportions and properties of the above components were all recorded in Table 1 and Table 2 below.

TABLE 1

| | | | | | Comparative |
|---|---|---|---|---|---|
| | Example 1 | Example 2 | Example 3 | Example 4 | example 1 |
| Organic content % | 75.0 | 74.4 | 78.4 | 84.5 | 51.5 |
| Inorganic content % | 25.0 | 25.6 | 21.6 | 15.5 | 48.5 |
| Hydrophobic aerogel | 6.25 | 4.2 | 3.3 | 6.2 | — |
| powders (A) | | | | | |
| Hollow powders (B) | 18.75 | 21.4 | 18.2 | 9.3 | — |
| A:B | 1:3 | 1:5.1 | 1:5.5 | 1:1.5 | — |
| Percentage elongation | 255 | 210 | 335 | 254 | 38 |
| (%) | | | | | |
| Thermal conductivity | 0.05260 | 0.05848 | 0.06434 | 0.06748 | 0.067 |
| (W/m · K) | | | | | |
| Thickener % | 0.6 | 0.8 | 0.4 | 0.8 | — |
| (based on resin | | | | | |
| content) | | | | | |
| Type of thickener | Associative | Associative | Associative | Associative | — |
| Viscosity (cP) @ | 420 | 380 | 455 | 400 | 300 |
| Shear rate 1000 s⁻¹ | | | | | |
| Viscosity recovery | 6980 | 6725 | 5850 | 6360 | 3320 |
| (cP) | | | | | |
| @ Shear rate 10 s⁻¹ | | | | | |
| Thixotropy | 16.6 | 17.7 | 12.8 | 15.9 | 11.0 |
| Film thickness mm | 2 | 2 | 1.5 | 2 | 0.5 |
| (upper limit without | | | | | |
| sagging) | | | | | |

TABLE 2

| | Comparative | Comparative | Comparative | Comparative | Comparative | Comparative |
|---|---|---|---|---|---|---|
| | example 2 | example 3 | example 4 | example 5 | example 6 | example 7 |
| Organic | 73.3 | 75.1 | 86.2 | 60.8 | 74.5 | 87 |
| content % | | | | | | |
| Inorganic | 26.7 | 24.9 | 13.8 | 39.2 | 25.5 | 12 |
| content % | | | | | | |
| Hydrophobic | 0 | 3.1 | 2.8 | 7.8 | 5.1 | 12 |
| aerogel | | | | | | |
| powders (A) | | | | | | |
| Hollow | 26.7 | 21.8 | 11 | 31.4 | 20.4 | 0 |
| powders (B) | | | | | | |
| A:B | — | 1:7 | 1:4 | 1:4 | 1:4 | — |
| Percentage | 46 | 118 | 285 | 87 | 255 | 30 |
| elongation (%) | | | | | | |
| Thermal | 0.06868 | 0.06345 | 0.07922 | 0.05676 | 0.0526 | 0.06908 |
| conductivity | | | | | | |
| (W/m · K) | | | | | | |
| Thickener % | 0.5 | 0 | 0.3 | 0 | 0.8 | 1.0 |
| (based on | | | | | | |
| resin | | | | | | |
| content) | | | | | | |
| Type of | Associative | — | Associative | — | Non- | Non- |
| thickener | | | | | associative | associative |
| Viscosity (cP) | 330 | 482 | 355 | 218 | 360 | 320 |
| @ Shear rate | | | | | | |
| 1000 s⁻¹ | | | | | | |
| Recovery | 4010 | 1114 | 3980 | 690 | 3200 | 1540 |
| Viscosity | | | | | | |
| recovery (cP) | | | | | | |
| @ Shear rate | | | | | | |
| 10 s⁻¹ | | | | | | |
| Thixotropy | 12.2 | 2.3 | 11.2 | 3.2 | 8.9 | 4.8 |
| Film thickness | 1.2 | 0.2 | 0.5 | 0.3 | 0.4 | 0.3 |
| mm (upper limit | | | | | | |
| without sagging) | | | | | | |

It be seen from Table 1 and Table 2 that Examples 1 to 4 with high organic content (70% to 85%) still maintain low thermal conductivity (0.05 W/m·K to 0.07 W/m·K) and good ductility. Moreover, the thixotropy of Examples 1 to 4 is ≥10, which is conductive to high-thickness film formation, which thickness may reach 1 mm to 2 mm without sagging. On the other hand, Comparative example 1 and Comparative example 5 have low organic content, resulting in poor ductility. Comparative example 2 which does not contain hydrophobic aerogel powders also has poor elongation. Comparative example 3 and Comparative examples 5 to 7 which do not contain an associative resin thickener, and have thixotropy that are all lower than 10. Even if the thickener was increased to 1.0% in Comparative example 7, it is impossible to apply a coating with high film thickness, and sagging easily occurred even with a single coating thickness of 0.3 mm. Comparative example 4 contains excessive organic content, and therefore the thermal insulation is insufficient, and sagging already occurred at a coating thickness of 0.5 mm.

### <Different Associative Resin Thickeners>

The same components and process as in Example 1 were adopted to prepare the thermal insulation coating composition. In addition to the originally used ELEMENTIS RHEOLATE® R288, the following two associative resin thickeners and a non-associative resin thickener (BYK RHEOBYK-420) were also be applied. An additional thermal insulation coating composition without an associative resin thickener was prepared as a control.

Associative resin thickener: BYK RHEOBYK-H7625VF (polyurethane solution), BYK RHEOBYK-425 (urea-modified polyurethane solution).

Then, using a controllable shear force/shear rate rheometer measurement, the shear rate ramped up from 10 s⁻¹ to 1000 s⁻¹ and then ramped down to 10 s⁻¹ as one cycle. The values changing with the shear rate were recorded to obtain the viscosity and the viscosity recovery recorded in Table 3 below.

TABLE 3

| | | RHEOBYK- | RHEOBYK- | RHEOBYK- | RHEOLATE |
|---|---|---|---|---|---|
| Product number | — | 420 | H7625VF | 425 | ® R288 |
| Type of thickener | — | Non- | Associative | Associative | Associative |
| | | associative | | | |
| Thickener % | 0 | 0.3 | 0.3 | 0.3 | 0.3 |
| (based on resin | | | | | |
| content) | | | | | |
| Viscosity (cP) @ | 317 | 310 | 287 | 326 | 379 |
| Shear rate 1000 s⁻¹ | | | | | |
| Viscosity recovery | 1300 | 1520 | 1705 | 3320 | 3990 |
| (cP) @shear rate 10 s⁻¹ | | | | | |
| Thixotropy | 4.1 | 4.9 | 5.9 | 10.18 | 10.5 |

It may be seen from Table 3 that the thermal insulation coating composition with the addition of an associative resin thickener may have low viscosity at high shear rate and may recovery to a higher viscosity target High viscosity recovery indicated that sagging is less likely to occur, while maintaining low viscosity during spraying, and is conducive to coating fluidity.

### <Addition Amount of Associative Resin Thickener>

The thermal insulation coating composition was prepared using the same components and process as in Example 1, except that RHEOLATER R288 was used in a different amount as the associative resin thickener.

Then, the viscosity, viscosity recovery, thixotropy, and coating thickness without sagging were obtained using the above test method and recorded in Table 4 below.

TABLE 4

| Thickener amount % | | | | | |
|---|---|---|---|---|---|
| (based on resin content) | 0 | 0.2 | 0.4 | 0.5 | 0.6 |
| Viscosity (cP) @shear | 317 | 394 | 405 | 421 | 420 |
| rate 1000 s⁻¹ | | | | | |
| Viscosity recovery (cP) | 1300 | 2515 | 3740 | 4660 | 6980 |
| @shear rate 10 s⁻¹ | | | | | |
| Thixotropy | 4.1 | 6.4 | 9.2 | 11.1 | 16.6 |
| Film thickness | 0.3 | 0.35 | 0.4 | 0.5 | 2 |
| mm (upper limit | | | | | |
| without sagging) | | | | | |

It may be seen from Table 4 that the greater the amount of the associative resin thickener added, the greater the upper limit of non-sagging coating film thickness. It is not necessarily better to add more associative resin thickener. The increase in spray viscosity is not conducive to manufacturing processability. Therefore, in the disclosure, the weight of the organic component is 100 parts by weight, and the content of the associative resin thickener should be 0.1 part by weight to 1 part by weight.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A thermal insulation coating composition, comprising:
an aqueous resin, wherein based on 100 parts by weight of a total amount of the thermal insulation coating composition, a content of the aqueous resin is 70 parts by weight to 85 parts by weight;
a hydrophobic aerogel powder, wherein based on 100 parts by weight of the total amount of the thermal insulation coating composition, a content of the hydrophobic aerogel powder is 2 parts by weight to 15 parts by weight;
a hollow powder, wherein based on 100 parts by weight of the total amount of the thermal insulation coating composition, a content of the hollow powder is 10 parts by weight to 25 parts by weight; and
an associative resin thickener, wherein based on 100 parts by weight of an amount of the aqueous resin, a content of the associative resin thickener is 0.1 part by weight to 1 part by weight.

2. The thermal insulation coating composition of claim 1, wherein the aqueous resin comprises an acrylic resin, a polyurethane resin, or a combination thereof.

3. The thermal insulation coating composition of claim 1, wherein the hydrophobic aerogel powder comprises a silica aerogel.

4. The thermal insulation coating composition of claim 1, wherein the hollow powder comprises a hollow glass sphere, a hollow plastic microsphere, or a combination thereof.

5. The thermal insulation coating composition of claim 1, wherein a weight ratio of the hydrophobic aerogel powder and the hollow powder is between 1:1 and 1:6.

6. The thermal insulation coating composition of claim 1, wherein the associative resin thickener comprises a polyether poly(urethane-urea) polymer.

7. The thermal insulation coating composition of claim 1, further comprising an additive, and a content of the additive is 0.1 part by weight to 1 part by weight based on 100 parts by weight of the amount of the aqueous resin.

8. The thermal insulation coating composition of claim 7, wherein the additive comprises a dispersant, a defoaming agent, a leveling agent, or a combination of the above.

9. A thermal insulation coating, which is a film formed by spraying the thermal insulation coating composition of claim 1.

10. The thermal insulation coating of claim 9, wherein the thermal insulation coating is a coating obtained by spraying multiple times.

11. The thermal insulation coating of claim 10, wherein the thermal insulation coating has a single coating thickness of 1 mm to 2 mm, a thermal conductivity of 0.05 W/m·K to 0.07 W/m·K, a thixotropy of ≥10, and a percentage elongation of ≥150%.

12. The thermal insulation coating of claim 10, wherein a thermal resistance value of a single coating of the thermal insulation coating is ≥0.03 m²·K/W.
